(19) United States
(12) Patent Application Publication
(10) Pub. No.: US 2023/0296282 A1
(43) Pub. Date: Sep. 21, 2023

(54) HUMIDIFIER WITH FLAME-LIKE VAPOR

(71) Applicant: DUPRAY VENTURES INC., Montreal (CA)

(72) Inventors: Brent GRAY, Montreal, QC (CA); Michel MORAND, Verdun, QC (CA); Guillaume CAVALIE, Montreal, QC (CA)

(21) Appl. No.: 18/018,689

(22) PCT Filed: Jul. 29, 2021
(86) PCT No.: PCT/CA2021/051068

§ 371 Date: Jan. 30, 2023

Related U.S. Application Data
(60) Provisional application No. 63/059,546, filed on Jul. 31, 2020.

(51) Int. Cl. F24F 13/078; F24F 6/02; F21S 10/04

(52) U.S. Cl. CPC F24F 13/078; F24F 6/025; F21S 10/04; F21S 10/002

(57) ABSTRACT

A humidifier apparatus may have at least one reservoir configured for holding a liquid. At least one device is for creating vapour from the liquid. At least one ventilator may cause a movement of the vapour exiting the reservoir. One or more light sources project lights on the movement of vapour. A method for operating a humidifier apparatus and creating flame-like vapor.

### CROSS-REFERENCE TO RELATED APPLICATION

The present application claims the priority of U.S. Patent Application No. 63/059,546, filed on Jul. 31, 2020 and incorporated herein by reference.

### FIELD OF THE INVENTION

The present application relates to humidifiers such as humidifiers used domestically in self-contained formats.

### BACKGROUND OF THE INVENTION

Humidifiers are commonly used in facilities in order to increase and control a relative humidity of a room or larger spaces. Humidifiers create water vapour to the surrounding environment by way of heating elements or like active elements such as ultrasound devices. While in some industrial embodiments humidity control may be integrated into ventilation systems, in smaller scale facilities, such as in homes, humidifiers are self-contained apparatuses that generate vapour or steam. However, such humidifiers are not necessarily esthetically pleasing, often consisting of box-shaped systems that do not blend in well with the surrounding environment. It would be desirable to add esthetic features to humidifiers.

### SUMMARY

In one aspect, there is provided a humidifier apparatus comprising: at least one reservoir configured for holding a liquid, at least one device for creating vapour from the liquid, at least one ventilator for causing a movement of the vapour exiting the reservoir; and at least one light source to project light on the movement of vapour.

Further in accordance with the aspect, for example, the at least one reservoir is part of a first reservoir compartment being annular and surrounding a volume.

Still further in accordance with the aspect, for example, the at least one ventilator includes at least one ventilator in the volume configured to cause a generally upward air flow in the volume.

Still further in accordance with the aspect, for example, a base compartment is provided with the first reservoir compartment being positioned on top of the base compartment.

Still further in accordance with the aspect, for example, vent holes are in a bottom of the base compartment and define an air passage in fluid communication with the volume.

Still further in accordance with the aspect, for example, a centerpiece defines an inner surface of the volume.

Still further in accordance with the aspect, for example, the centerpiece defines a chimney configured to direct vapour exiting the reservoir upwardly.

Still further in accordance with the aspect, for example, the centerpiece has a cylindrical tubular portion and/or an inverted frusto conical tubular portion.

Still further in accordance with the aspect, for example, the centerpiece has the cylindrical tubular portion and the inverted frusto conical tubular portion on top of the cylindrical tubular portion.

Still further in accordance with the aspect, for example, the at least one ventilator includes at least one ventilator in the chimney configured to cause a generally upward vapour flow.

Still further in accordance with the aspect, for example, a second reservoir compartment is annular and surrounding the volume.

Still further in accordance with the aspect, for example, the second reservoir compartment is positioned on top of the first reservoir compartment.

Still further in accordance with the aspect, for example, the second reservoir compartment defines the chimney with the centerpiece.

Still further in accordance with the aspect, for example, slits are defined between the second reservoir compartment and the centerpiece, the slits configured to direct vapour to the volume to be entrained by an air flow in the volume.

Still further in accordance with the aspect, for example, the slits are circumferentially distributed around the centerpiece.

Still further in accordance with the aspect, for example, a flow control device is at a bottom of the second reservoir compartment, and is configured to control an amount of water moved from the second reservoir compartment to the first reservoir compartment.

Still further in accordance with the aspect, for example, the flow control device includes a spring-biased piston abutting against an abutment of the first reservoir compartment to remain opened when the second reservoir compartment is installed in the first reservoir compartment.

Still further in accordance with the aspect, for example, the at least one light source is in the volume.

Still further in accordance with the aspect, for example, the at least one light source includes at least one light-emitting diode.

Still further in accordance with the aspect, for example, the device for creating vapour is an ultrasound device.

Still further in accordance with the aspect, for example, the device for creating vapour includes a heating element to pre-heat the water.

Still further in accordance with the aspect, for example, the ultrasound device is the only device for creating vapour in the humidifier apparatus.

Still further in accordance with the aspect, for example, a controller controls a projection of light by the at least one light source.

Still further in accordance with the aspect, for example, at least one leg supports a remainder of the humidifier apparatus from a ground or support surface.

Still further in accordance with the aspect, for example, the at least one leg separates the remainder of the humidifier apparatus from the ground or support surface by at least 10 inches.

In accordance with another aspect, there is provided a method for operating a humidifier apparatus comprising: creating vapour from a liquid in a reservoir; mechanically inducing a movement of the vapour; and emitting light and projecting the light in the movement of the vapour.

Further in accordance with the other aspect, for example, mechanically inducing a movement of the vapour includes blowing the vapour upwardly in an annular chimney.

Still further in accordance with the other aspect, for example, mechanically inducing a movement of the vapour includes directing the vapour to an upward air flow.

Still further in accordance with the other aspect, for example, projecting light in the movement of the vapour includes projecting light from a position in a volume guiding the upward air flow.

Still further in accordance with the other aspect, for example, emitting light includes varying a colour of light.

Still further in accordance with the other aspect, for example, creating vapour includes clearing vapour with an ultrasound device.

### DESCRIPTION OF THE FIGURES

Reference is now made to the accompanying figures in which:

FIG. 1 is a perspective view of a humidifier apparatus in accordance with the present disclosure, on legs;

FIG. 2 is a cross-sectional view of the humidifier apparatus of FIG. 1;

FIG. 3 is a section view of the humidifier apparatus of FIG. 1, illustrating an operation thereof;

FIG. 4 is a perspective view of a base compartment of the humidifier apparatus of FIG. 1;

FIG. 5 is a perspective view of a first reservoir compartment of the humidifier apparatus of FIG. 1;

FIG. 6 is a perspective view of a second reservoir compartment, a chimney and a cover of the humidifier apparatus of FIG. 1;

FIG. 7 is another perspective view of the assembly of FIG. 6, showing a water level control unit at a bottom thereof;

FIG. 8 is a cross-sectional view showing the water level control unit of FIG. 7.

### DESCRIPTION OF THE PREFERRED EMBODIMENTS OF THE EMBODIMENTS

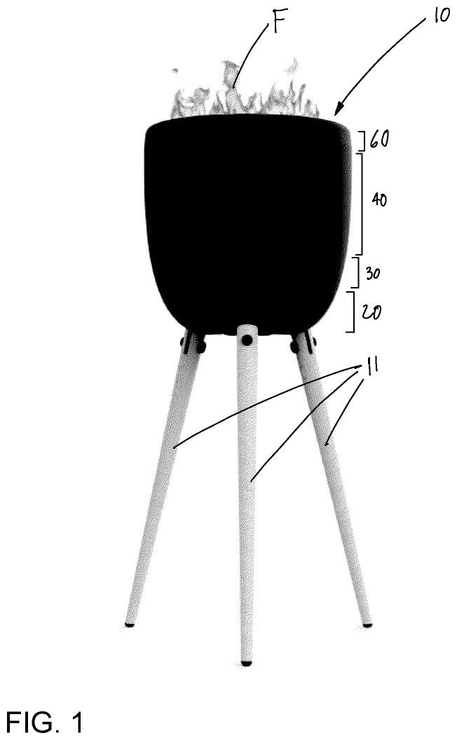

Referring to the drawings and more particularly to FIG. 1, a humidifier apparatus in accordance with the present disclosure is generally shown at 10. The humidifier apparatus 10 is used to output water vapour or steam for instance to increase a humidity level of an environment. The expression “humidifier” is used for the apparatus 10 as humidity is generated, and may imply generating ambient humidity to increase the ambient relative humidity in the air. The humidifier apparatus 10 is not enclosed to allow the vapour to be released to ambient. However, the humidifier apparatus 10 may be used as a faux fireplace or other decorative element. The expressions vapour and steam may be used interchangeably herein to designate the gaseous state of a liquid such as water, that will result from actuation of the humidifier apparatus 10. If steam is deemed to differ from vapour in that steam results from heating, than the humidifier apparatus 10 may produce both steam, by actuation, and vapour, by evaporation. In an embodiment, the humidifier apparatus 10 is used without a heat source, and relies on evaporation to produce vapour. The expression fog may also be used as well. The use of steam and vapour herein is however used to describe the gaseous state of the liquid that results from the use and powering of the humidifier apparatus 10. However, when the humidifier apparatus 10 creates an open-flame like vapour, as in FIG. 1, it is strongly preferred to have vapour at a temperature much lower than 100° C. for safety reasons. If the humidifier apparatus 10 is used as a decorative apparatus (e.g., faux fireplace), and is concealed for instance behind protective glass, it may be considered to have a higher temperature.

The humidifier apparatus 10 is said to be a self-contained apparatus 10 in that, outside of the power it receives from the power grid, the humidifier apparatus 10 may produce steam when powered and filled with a liquid, i.e., it can produce its own vapour. In another embodiment, the humidifier apparatus 10 has its own battery, and may be operated without being connected to a power source.

The humidifier apparatus 10 is shown as having legs 11, by which functional components of the humidifier apparatus 10 is supported, though the humidifier apparatus 10 may be without such legs 11. It is observed that the humidifier apparatus 10 has the capacity of emitting a flame-like vapour F based on the components described hereinafter. The humidifier apparatus 10 may comprise one or more of a base compartment 20, a first reservoir compartment 30, a second reservoir compartment 40, a centerpiece 50, a cover 60, a water level control unit 70, a, optional heater 80, an ultrasound device 90, a central ventilator 100, a vapour ventilator 110, and a controller 120 (e.g., such as PC board with appropriate components). An exemplary functionality of these components is as follows:
The base compartment 20 forms a structural part of the humidifier apparatus 10. The base compartment 20 may enclose one or more of the components of the humidifier apparatus 10 and is the interface with the legs 11 if the legs 11 are present. The humidifier apparatus 10 may sit on the base compartment 20. The base compartment 20 may support the other compartments 30 and 40, if present.
The first reservoir compartment 30 holds a liquid and is tasked with exposing the liquid to an upward airflow and/or to an energy source so as to create the vapour.
The second reservoir compartment 40 is optionally present to hold additional liquid and to feed the first reservoir compartment 30.
The centerpiece 50 plays a role in creating the flame-like vapour by directing an airflow onto vapour produced by the humidifier apparatus 10.
The cover 60 may be present to conceal the interior of a reservoir, such as that of the second reservoir compartment 40.
The water level control unit 70 may optionally be present and located between the first reservoir compartment 30 and the second reservoir compartment 40 to control the level of liquid in the first reservoir compartment 30. The water level control unit 70 may also ensure that the vaporizing elements are exposed to the appropriate amount of water to produce a suitable amount of vapour.
The heater 80 is optionally present to preheat the liquid in a reservoir of the humidifier apparatus 10, such as in the first reservoir compartment 30 as shown in the embodiments herein.
The ultrasound device 90 is optionally present to vaporize water in the humidifying process. The heater 80 and the ultrasound device 90 may be integrated in a single heater device that will create the vapour.
The central ventilator 100 creates an airflow in the chimney that will cause the flame-like appearance of the vapour.
The vapour ventilator 110 is tasked with directing the vapour out of the humidifier apparatus 10.
The controller 120 operates the various components of the humidifier apparatus 10.

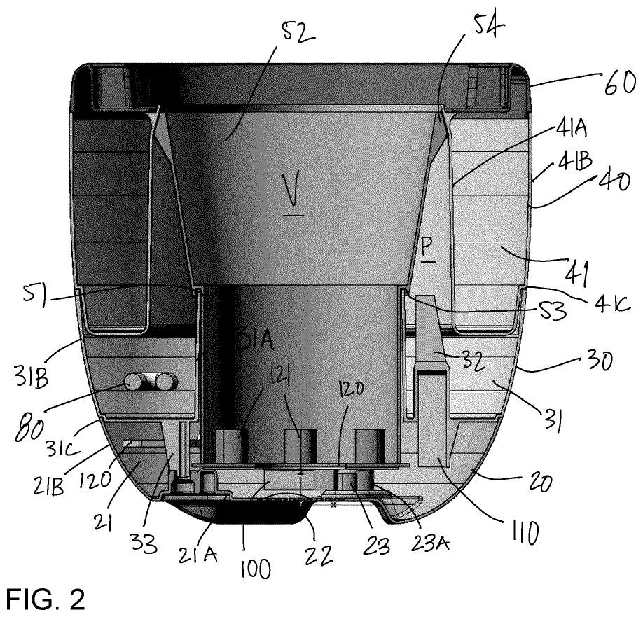

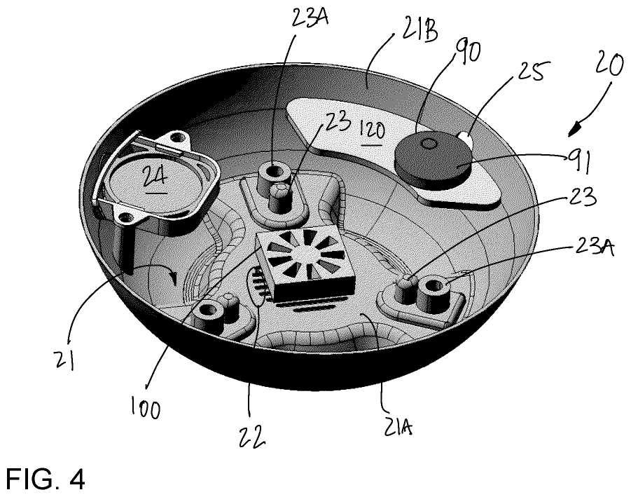

Referring concurrently to FIGS. 2 to 4, the base compartment 20 is shown in greater detail. The base compartment 20 may be a one-piece moulded component that defines some of the parts described herein. Other constructions are contemplated. The base compartment 20 has a receptacle 21, i.e., an inner cavity, that will accommodate components. In the receptacle 21, a raised portion 21A may be present, as a result of the footings on the bottom exterior of the base compartment 20 that will be the bottommost portion of the base compartment 20, upon which the base compartment 20 may stand when laid directly on the ground or other flat surface.

An outer wall 21B delimits the receptacle 21, and its periphery may be said to be continuous. A top peripheral edge of the outer wall 21B may lie in a plane to which the gravity vector is normal when the humidifier apparatus 10 is used as in FIG. 1 (though this is merely an option). According to an embodiment, vent slots 22 (a.k.a., vents, holes, passages) are defined in the wall 21B of the receptacle, such as in the raised portion 21A for fluid to communicate therethrough, from an exterior of the humidifier apparatus 10 to an interior thereof, and vice versa. For instance, the vent slots 22 will be used for air circulation to provide an air source to the central ventilator 100 as described below. While the footings shown allow the raised portion 21A and vent slots 22 to be raised from the ground or support surface, additional clearance from the ground or support surface to facilitate an air intake and promote a laminar-like upward flow of air or reduce turbulence in the air flow. Stated differently, the spacing of the vent slots 22 from the ground or support surface may contribute to an upward vector of the air flowing through the humidifier apparatus 10. In an embodiment, by way of the legs 11, the clearance between the vent slots 22 and the ground is of at least 10 inches. Posts 23 may be formed into the material of the base compartment, some of which have holes such as shown as 23A. The posts 23 without holes may be provided to structurally support various components, while the posts 23 with holes 23A may be used to fix the first reservoir compartment 30 to the base compartment 20, to ensure the base compartment 20 and the first reservoir compartment 30 remain connected. A tray 24 may be present. The tray 24 is openable to insert an odorant item or fragrance, for instance in the form of essential oils. The convection of air resulting from the vent slots 22 may entrain molecules of fragrance. Cord hole 25 is defined in the outer wall 21B for a power chord to be connected to the controller 120.

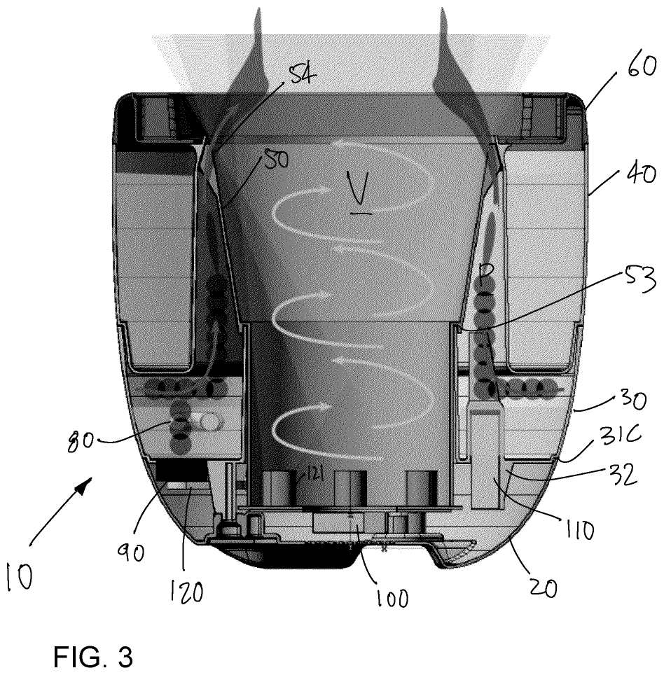

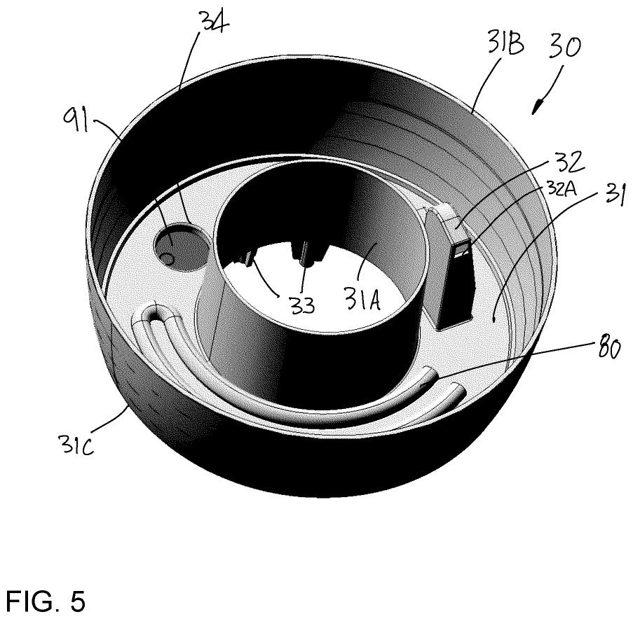

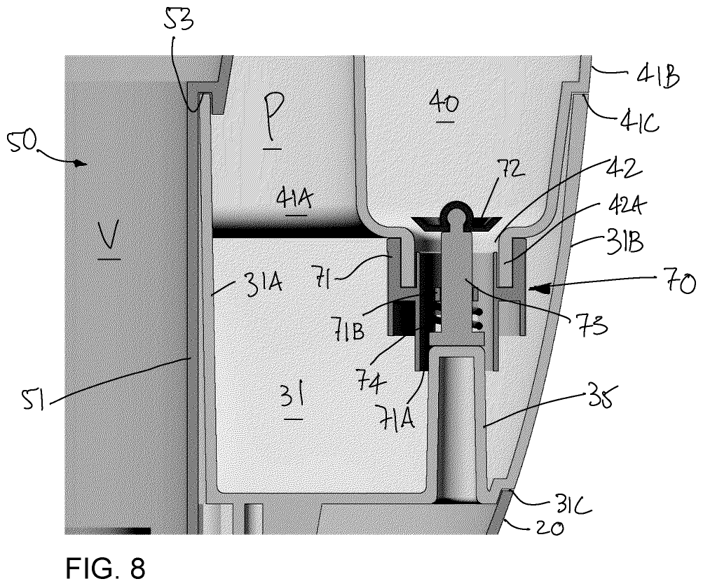

Referring to FIGS. 2, 3, and 5, the first reservoir compartment 30 is shown in greater detail. The first reservoir compartment 30 may be a one-piece moulded component that defines some of the parts described herein. Other constructions are contemplated. The first reservoir compartment 30 also has a receptacle 31 that is delimited by a central tube 31A and an outer wall 31B. Accordingly, the first reservoir compartment 30 may be described as defining a tubular receptacle, defining an inner cavity that serves as a liquid reservoir (i.e., tank, receiver) that is open from a top. The inner cavity may therefore have an annular shape with cylindrical inner and outer walls, but this is only an option. Other shapes may include square, squircle, rectangular, and the inner and outer walls need not be similar in shape. As observed from FIGS. 2 and 3, a shoulder 31C may optionally be defined in the outer wall 31B, by which the first reservoir compartment 30 sits on the outer wall 21B of the base compartment 20, for instance to form a continuous surface at the junction between the base compartment 20 and the first reservoir compartment 30. Duct 32 or like fluid passage may project upwardly from a bottom portion of the outer wall 31B of the first reservoir compartment 30. The duct 32 is in fluid communication with the vapour ventilator 110 in the manner described hereinbelow. Therefore, the duct 32 has an opening 32A (FIG. 5) that will be above a water level in the first reservoir component 30. Legs 33 project downwardly from the receptacle 31. The legs 33 are complementary to the posts 23A such that fasteners may be used to tie the first reservoir compartment 30 to the base compartment 20. Cavity 34 is also in the bottom portion of the outer wall 31B of the receptacle 31. The cavity 34 may be a small receptacle that will receive a component of the ultrasound device 90 to vaporize the liquid that in the reservoir of the first reservoir compartment 30. As an alternative to a cavity, 34 may be a hole by which the ultrasound device 90 supported by the base compartment 20, communicates with the liquid in the first reservoir component 30. It is also seen that the heater 80 is present in the first reservoir compartment 30, in this embodiment, but it is optional. An abutment 35 (FIG. 8) may also be present, for cooperation with the water level control unit 70 as described below.

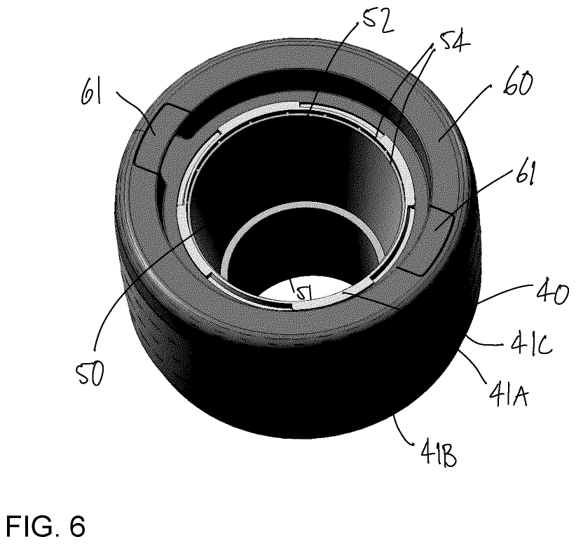

Referring concurrently to FIGS. 2, 3, and 6, the second reservoir compartment 40 is shown as being seated on the first reservoir compartment 30. The second reservoir compartment 40 may be a one-piece moulded component that defines some of the parts described herein. Other constructions are contemplated. The second reservoir compartment 40 is a secondary reservoir for liquid, and is optionally present. In an embodiment, the second reservoir compartment 40 is readily detachable from the first reservoir compartment 30, for instance to fill up the second reservoir compartment 40. It also has a receptacle 41 with a central tubular wall 41A, an outer wall 41B and a shoulder 41C, all of circular cross-section as illustrated, but with other shapes being possible, as described above. The shoulder 41C sits on the outer wall 31B of the first reservoir compartment 30. In an embodiment, they are not tied, with the second reservoir compartment 40 just seated on the first reservoir compartment 30. This may enable the removal of the second reservoir compartment 40 so as to fill it up with liquid. A hole 42 (FIG. 8) may be present, for collaboration with the water level control unit 70 as described below. It is possible to provide attachment features for the releasable connection of the second reservoir compartment 40 to a remainder of the humidifier apparatus 10.

Still referring to FIGS. 2, 3, and 6, the centerpiece 50 is shown in greater detail. The centerpiece 50 may be a one-piece moulded component that defines some of the parts described herein. Other constructions are contemplated. In an embodiment, the centerpiece 50 has a bottom tubular portion 51, and an upper tubular portion 52. The bottom tubular portion 51 may be cylindrical in shape, while the upper tubular portion 52 may be an inverted frusto-cone. A channel 53 or shoulder may be present at the junction between the bottom tubular portion 51 and the upper tubular portion 52. The channel 53 may therefore sit on the rim of the central tubular wall 41A of the second reservoir compartment 40 to make a generally fluid-tight junction therebetween, or equivalent vapour barrier. Additional seals may be present. As an alternative to the embodiment shown, the centerpiece 50 may be a straight cylindrical portion from bottom to top with a flange, or a frusto-cone from bottom to top as well, as possible options among others, as detailed above. Openings such as slits 54 may be provided at the top edge of the upper tubular portion 52 and are present for vapour to exit the centerpiece 50. The slits 54 may define passages with the central tubular wall 41A of the second reservoir compartment 40. In an embodiment, the openings are elongated, meaning that they have a length that is at least twice the width (or height). This is a possibility among others. For example, an annular gap may separate the upper tubular portion 52 from the central tubular wall 41A. Moreover, in an embodiment, as shown in FIG. 3, the top end of the central tubular wall 41A of the second reservoir compartment 40 may taper radially inwardly, such that the openings or slits 54 are oriented inwardly, whereby steam exiting through the slits 54 has a radially inward direction vector component. The centerpiece 50 may be fixed to the base compartment 20 and/or the first reservoir compartment 30 so as to remain connected thereto while the second reservoir compartment 40 is removed to be filled up, if necessary. The centerpiece 50 could also be tied to the second reservoir compartment 40 to move therewith.

The cover 60 may be sealingly mounted to the second reservoir compartment 40 in an embodiment, such that an interior of the reservoir formed concurrently by the second reservoir compartment 40 and the cover 60 is substantially air tight, with the exception of closeable fill holes, such as the hole 42 (FIG. 8) in the second reservoir compartment 40. Handles 61 may optionally be present in the cover 60 to facilitate the handling of the assembly defining the secondary reservoir, i.e., the second reservoir compartment 40 and the cover 60. In an embodiment, the secondary reservoir has a storage capacity that is at least double that of the first reservoir.

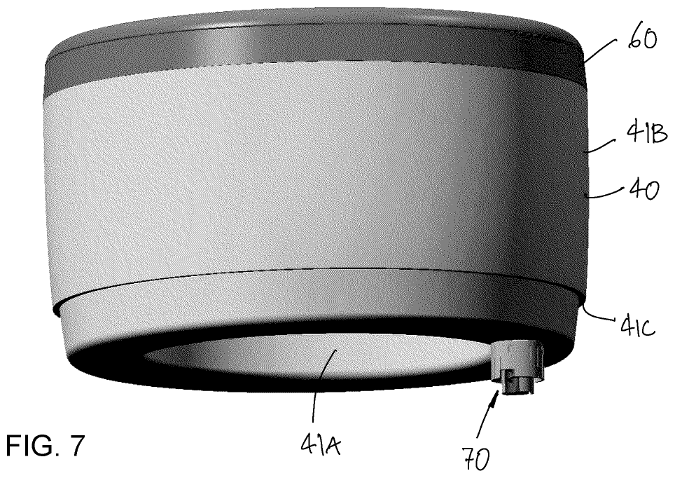

Referring to FIGS. 7 and 8, the water level control unit 70 may be present so as to control the amount of liquid flowing to the first reservoir compartment 30 from the second reservoir compartment 40. In an embodiment, the water level control unit 70 has a tubular mount 71 mounted to the hole 42 in the second reservoir compartment 40, such as to a tubular formation 42A defining the hole 42. The tubular mount 71 may form a fluid passage 71A for water to flow into the first reservoir compartment 30 from the second reservoir compartment 40. A plug 72 may be present so as to selectively close fluid passage 71A. The tubular mount 71 may further include a piston 73 that translates within the tubular mount 71, and to which is connected the plug 72. Spring 74 may be present to bias the piston 73 downwardly by contact with a ring 71B of the tubular mount 71, whereby the plug 72 blocks the fluid passage 71A. This scenario occurs for instance when the second reservoir compartment 40 is separated from the first reservoir compartment 30.

As observed from FIG. 8, when the second reservoir compartment 40 is seated onto the first reservoir compartment 30, as in FIG. 2, the abutment 35 comes into contact with the piston 73, thus acting against the spring 74 and forcing the plug 72 upwardly, thereby opening the fluid passage 71A. By the effect of gravity, water may consequently flow from the secondary reservoir to the first reservoir compartment 30. However, as the fluid passage 71A is the only open fluid passage in and out of the secondary reservoir, gas must be allowed to flow upwardly into the secondary reservoir for liquid to flow into the first reservoir compartment 30. As long as the water level is above the bottom rim of the fluid passage 71A, water is prevented from flowing out of the secondary reservoir. This ensures that the level of water in the first reservoir compartment 30 remains at a given level when the secondary reservoir holds liquid.

Alternatives to this arrangement are contemplated. For instance, a solenoid valve, a float system, etc, could be present to control the flow from the secondary reservoir to the first reservoir compartment 30. In another embodiment, there is no secondary reservoir, with the first reservoir compartment 30 forming the sole liquid reservoir. In such an embodiment, the cover 60 may be mounted directly to the top of the first reservoir compartment 30.

The heater 80, if present may be for instance an electric coil that is submerged into the water to preheat the water, such as in the reservoir of the first reservoir compartment 30, though the preheating may not be necessary. The electric coil may be covered by a ceramic or like sheathing covering a metallic resistor of the electric coil. For example, the water is heated to a temperature between 42° C. and 48° C. The heater 80 may be in the reservoir of the first reservoir compartment 30 and/or in the secondary reservoir of the second reservoir compartment 40. The heater 80 may be used alone to vaporize the water, or pre-heat the water to facilitate the vaporization by ultrasound. In an embodiment, the heater 80 and ultrasound device 90 are used in a two-stage heating approach, to increase the temperature of the water for the vapour output from the ultrasound device 90 to be increased. In an embodiment, the heater 80 is only used when water is below a given threshold, with the ultrasound device 90 being the primary component to control vaporization.

The ultrasound device 90 has an emitter 91 that is submerged in the liquid of the first reservoir, for instance through the cavity 34. In an embodiment, it is necessary to operate the ultrasound device 90 only when the emitter 91 is submerged. Therefore, a liquid detector or liquid detecting feature and/or an auto shutoff feature may be present to ensure the ultrasound device 90 operates only when the emitter 91 is submerged. In addition to the heater 80 and/or the ultrasound device 90, other means for generating vapour may be used, including a laser source, a radiator, an infrared emitter, among numerous other possibilities.

In an embodiment, the level of water above the ultrasound device 90 must be controlled, to ensure the efficient creating of vapour. The water level control unit 70 is well suited to ensure that the amount of water remains within the desired levels. Moreover, sensors may be present and associated with the controller 120 to ensure that the ultrasound device 90 does not operate if there is too little water. Other systems may be used, such as a pump that is operated to maintain the appropriate level of water.

Referring to FIGS. 2 and 3, the central ventilator 100 is located in the base compartment 20, for instance close to the vent slots 22. The central ventilator 100 induces an upward flow of air, through a volume V of the centerpiece 50, i.e. a central volume. In an embodiment, the central ventilator 100 is one or more axial fans, such as fans used in personal computers. Components such as grills, guards may be present, for example at the bottom of the centerpiece 50, to define protection from or for the impellers of the central ventilator 100.

Referring to FIGS. 2 and 3, the vapour ventilator 110 is located in a volume or chimney P defined concurrently by the first reservoir compartment 30, the second reservoir compartment 40, and the centerpiece 50. In an embodiment featuring only one reservoir, the chimney may be defined by the first reservoir compartment 30 and the centerpiece 50. Therefore, vapour that is created at the surface of the liquid in the first reservoir compartment 30 may be assisted out through the slits 54. The vapour ventilator 110 forces the vapour out of the chimney P, through the openings 54, such that the vapour reaches the centerpiece 50 and meets the upward flow of air of the volume V. In an embodiment, the vapour ventilator 110 is a blower increasing a pressure in the chimney. For example, a blower fan may be used. Other types of ventilators may be present such as squirrel cage, axial, centrifugal. Moreover, the humidifier apparatus 10 may be without the vapour ventilator 110, relying instead in a Venturi effect at the slits 54 and/or on humidity saturation, for example, to ensure that the vapour exits the chimney P into the volume V of the centerpiece 50, via the openings such as the slits 54, that may be circumferentially distributed to form a disrupted annular exhaust for chimney P.

The controller 120 is in charge with the operation of the humidifier apparatus 10. The controller 120 may be a processing unit, and may have a non-transitory computer-readable memory communicatively coupled to the processing unit and comprising computer-readable program instructions executable by the processing unit for operating the humidifier apparatus 10. The controller 120 is powered, for instance by being connected to the grid by a power cord, or by connection to a battery. The controller 120 may include a printed circuit board and may be wired to the various powered components of the humidifier apparatus 10, such as the heater 80, the ultrasound device 90, the central ventilator 100, the vapour ventilator 110. Moreover, the controller 120 may include various other sensors, such as temperature sensors (e.g., thermocouple), water level sensors, relative humidity (RH) sensors. The controller 120 may also include a user interface, which may be one of an on/off switch, a GUI, a touch pad, with functions including RH control, mode control, colour control, intensity control. Various modes of operation may be available in addition to generating to the mode generating the flame-like vapour, such as a high mode in which the rate of generation of vapour is increased and the lighting is off, or a light-off mode in which vapour is generated without light. The light-off mode may be part of a sleep mode, in which the lights are turned off for sleep. Likewise, the lights may be turned on in a timer mode, for instance for the humidifier apparatus 10 to be used as an alarm. The controller 120 may also have wireless communication capacity, for a remote control, or that may be paired with a portable device such as a smart phone, tablet, etc, using protocols such as Bluetooth®, Wi-Fi, etc. Light sources 121 may be part of the controller 120, or independent devices operated by the controller 120. The light sources 121 may include one or more light-emitting diodes (LEDs) and may have the capacity of producing light in any desired range of the colour spectrum, with a preference for yellow-red-orange to emulate the colours of a flame. As alternatives to LEDs, light bulbs of any type may be used provided they are safe. The light sources 121 are not limited to such colours. The light sources 121 are in a bottom of the centerpiece 50 and face upwardly, such that light is diffused out of the volume V, with the vapour crossing the rays of light. Accordingly, the vapour is coloured by the light from the light sources 121. The light sources 121 may be operated to vary their colour over time.

During operation, the controller 120 drives the light sources 121 to emit light of a reddish orange colour. The heater 80 and the ultrasound device 90, if both present, cooperate in order to produce vapour with the liquid in the first reservoir compartment 30. The vapour ventilator 110 is operated in order to cause the vapour to exit through the slits 54. As vapour exits through the slits 54, it reaches the volume V of the humidifier apparatus 10. In doing so, the vapour is exposed to the convection airflow caused by the central ventilator 100. This will create the flame-like movement of the vapour, i.e., turbulent movement of the vapour. Concurrently, the vapour is coloured by the light from the light sources 121. The inverted frusto-cone of the upper tubular portion 52 may increase the area of projected light.

In an embodiment, the humidifier apparatus 10 may include at least a reservoir configured for holding a liquid, such as water. Means are provided for creating vapour from the liquid. One or more ventilators (e.g., 100, 110) mechanically induce a movement of the vapour exiting the reservoir. One or more light sources 121 project light on the movement of vapour. In an embodiment, the heat or ultrasound suffice in causing the suitable movement of vapour out of the chimney, whereby no ventilator (e.g., vapour ventilator 110) may be required. In another embodiment, a pumping system with heat exchanger or a boiler may be used to cause the suitable movement of vapour out of the chimney, in another option without the vapour ventilator 110.

The humidifier apparatus 10 is shown in a pot-like configuration, with a rounded shape, other shapes are considered. For example, the humidifier apparatus 10 may be in an elongated shape. Cross-section shapes may include circular, square, squircle, triangular, rectangular, any polygonal shape, oval, to name but a few options.

The controller 120 may be a processing unit, and may have a non-transitory computer-readable memory communicatively coupled to the processing unit and comprising computer-readable program instructions executable by the processing unit for: creating vapour from a liquid in a reservoir; mechanically inducing a movement of the vapour; and emitting light and projecting the light in the movement of the vapour.

In a variant, the humidifier apparatus 10 may be generally described as an upstanding tube, forming a generally vertical central air passage that has a ventilator or like mechanical device to induce an upward airflow. The upstanding tube is surrounded by a humidifier portion, that forms a sleeve-like annular chamber that opens to the vertical central air passage, such that vapour exiting the sleeve-like annular chamber is exposed to the upward airflow. The annular chamber may be concentric with the upstanding tube in an embodiment. Light(s) within the air passage may project light upwardly such that the vapour exiting the annular chamber is illuminated.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A humidifier apparatus comprising:
at least one reservoir configured for holding a liquid,
at least one device for creating vapour from the liquid,
at least one ventilator for causing a movement of the vapour exiting the reservoir; and
at least one light source to project light on the movement of vapour.

2. The humidifier apparatus according to claim 1, wherein the at least one reservoir is part of a first reservoir compartment being annular and surrounding a volume.

3. The humidifier apparatus according to claim 2, wherein the at least one ventilator includes at least one ventilator in the volume configured to cause a generally upward air flow in the volume.

4. The humidifier apparatus according to claim 3, further including a base compartment, with the first reservoir compartment being positioned on top of the base compartment.

5. (canceled)

6. The humidifier apparatus according to claim 2, including a centerpiece defining an inner surface of the volume.

7. The humidifier apparatus according to claim 6, wherein the centerpiece defines a chimney configured to direct vapour exiting the reservoir upwardly.

8. The humidifier apparatus according to claim 6, wherein the centerpiece has a cylindrical tubular portion and/or an inverted frusto conical tubular portion.

9. (canceled)

10. The humidifier apparatus according to claim 7, wherein the at least one ventilator includes at least one ventilator in the chimney configured to cause a generally upward vapour flow.

11. The humidifier apparatus according to claim 6, further including a second reservoir compartment being annular and surrounding the volume.

12. The humidifier apparatus according to claim 11, wherein the second reservoir compartment is positioned on top of the first reservoir compartment.

13. The humidifier apparatus according to claim 11, wherein the second reservoir compartment defines the chimney with the centerpiece.

14. The humidifier apparatus according to claim 13, wherein slits are defined between the second reservoir compartment and the centerpiece, the slits configured to direct vapour to the volume to be entrained by an air flow in the volume.

15. (canceled)

16. The humidifier apparatus according to claim 11, wherein a flow control device is at a bottom of the second reservoir compartment, and is configured to control an amount of water moved from the second reservoir compartment to the first reservoir compartment.

17. The humidifier apparatus according to claim 16, wherein the flow control device includes a spring-biased piston abutting against an abutment of the first reservoir compartment to remain opened when the second reservoir compartment is installed in the first reservoir compartment.

18. The humidifier apparatus according to claim 2, wherein the at least one light source is in the volume.

19. (canceled)

20. The humidifier apparatus according to claim 1, wherein the device for creating vapour is an ultrasound device.

21. The humidifier apparatus according to claim 20, wherein the device for creating vapour includes a heating element to pre-heat the water.

22. The humidifier apparatus according to claim 20, wherein the ultrasound device is the only device for creating vapour in the humidifier apparatus.

23. The humidifier apparatus according to claim 1, including a controller for controlling a projection of light by the at least one light source.

24. The humidifier apparatus according to claim 1, further including at least one leg supporting a remainder of the humidifier apparatus from a ground or support surface.

25.-31. (canceled)
